(19) United States
(12) Patent Application Publication
(10) Pub. No.: US 2012/0293898 A1
(43) Pub. Date: Nov. 22, 2012

(54) Thermal Cutoff Circuit

(75) Inventors: Meng-Chien Chiang, New Taipei City (TW); Chien-Ming Chen, Chiayi City (TW)

(73) Assignee: SERCOMM CORPORATION, Taipei (TW)

(21) Appl. No.: 13/112,372

(22) Filed: May 20, 2011

(51) Int. Cl. H02H 3/02

(52) U.S. Cl. 361/78

(57) ABSTRACT

A thermal cutoff circuit for an electronic device including a power unit, a thermal sensor, a logic unit, and a power switch unit is provided. The power unit includes a power switch for powering up the thermal cutoff circuit with a supply voltage in response to a user event. The thermal sensor provides an active thermal sense signal and an inactive thermal sense signal when a temperature of the electronic device exceeds a threshold and does not exceed the threshold, respectively. The logic unit provides an inactive cutoff signal and provides an active cutoff signal respectively according to the inactive thermal sense signal and the active thermal sense signal. The power switch unit powers the electronic device up according to the inactive cutoff signal and stops powering up the electronic device according to the active thermal sense signal.

### BACKGROUND OF THE INVENTION

1. Field of the Invention

The invention relates in general to a thermal cutoff circuit, and more particularly to a thermal cutoff circuit employing a switch push.

2. Description of the Related Art

Generally, temperatures of operation for electronic devices typically have an optimum range. When the electronic devices operate above or below the optimum range, damage of system components or malfunction of the electronic device may occur. Thus, it is critical to have devices, which are known as thermal cutoff circuits, for monitoring and managing the temperatures of operation for electronic devices, so as to prevent the electronic devices suffering from physical damage or malfunction.

### SUMMARY OF THE INVENTION

The invention is directed to a thermal cutoff circuit applied in an electronic device, wherein the thermal cutoff circuit employs a switch push for enabling a power switch to power up the electronic device in response to a user event. The thermal cutoff circuit further employs a circuit structure capable of preventing the switch push from damage caused by inrush current, which occurs when the electronic device is powered up. Thus, in comparison to conventional thermal cutoff schemes, the thermal cutoff circuit directed by the invention is capable of preventing the switch push from being damaged by inrush current.

According to an aspect of the present invention, a thermal cutoff circuit for an electronic device is provided. The thermal cutoff circuit includes a power unit, a thermal sensor, a logic unit, and a power switch unit. The power unit includes a switch push for powering up the thermal cutoff circuit with a supply voltage in response to a user event. The thermal sensor is powered up by the supply voltage for providing a thermal sense signal, which is active when a temperature of the electronic device exceeds a threshold and is inactive when the temperature does not exceed the threshold. The logic unit is powered up by the supply voltage for providing a cutoff signal, which is inactive when the thermal sense signal is inactive. The power switch unit is turned on for powering up the electronic device with a power source signal according to the inactive cutoff signal. The logic unit further provides the cutoff signal, which is active, according to the active thermal sense signal and the power switch unit is accordingly turned off and stops powering up the electronic device according to the active cutoff signal, so as to achieve thermal cutoff of the electronic device.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of the thermal cutoff circuit according to a first embodiment of the invention.

FIGS. 2A and 2B show partial circuit diagrams of the user interface circuit of the thermal cutoff circuit according to the present embodiment of the invention.

FIG. 3 shows a block diagram of the thermal cutoff circuit according to a second embodiment of the invention.

### DETAILED DESCRIPTION OF THE INVENTION

### First Embodiment

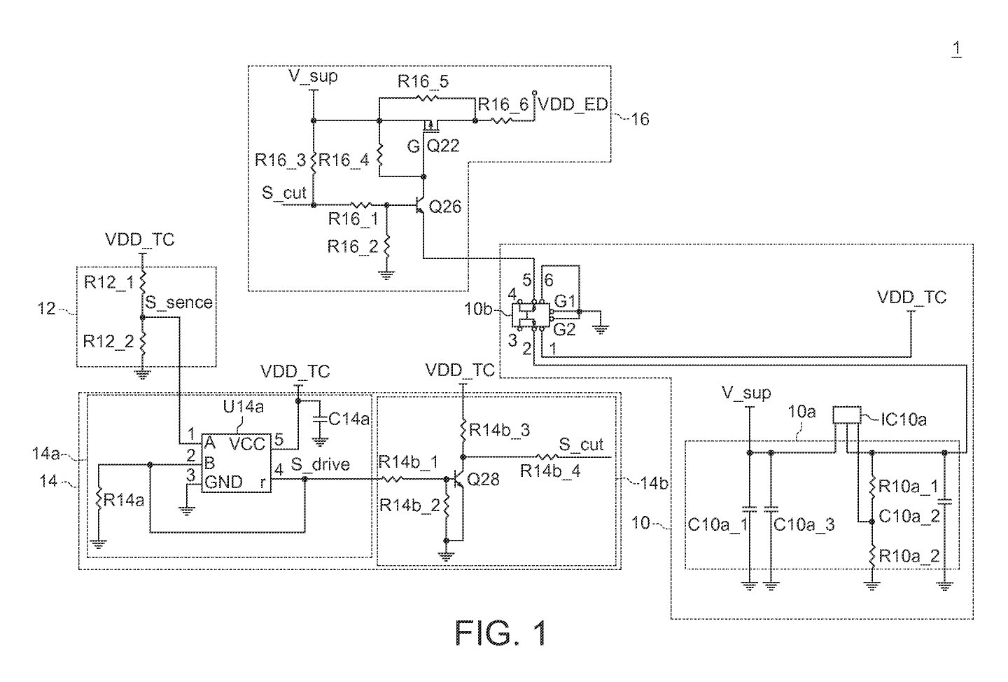

Referring to FIG. 1, a block diagram of the thermal cutoff circuit according to the first embodiment of the invention is shown. The thermal cutoff circuit 1 is employed in an electronic device (not shown) for applying thermal cutoff protection thereon. The thermal cutoff circuit 1 includes a power unit 10, a thermal sensor 12, a logic unit 14, and a power switch unit 16.

The power unit 10 powers up the thermal cutoff circuit 1 with a supply voltage VDD_TC in response to a user event. In an embodiment, the power unit 10 includes a power node, a low dropout voltage regulator (LDO) 10a, and a switch push 10b. The power node is connected to other components, e.g. thermal sensor 12 and logic unit 14, of the thermal cutoff circuit 1 and for providing the supply voltage VDD_TC thereto.

The LDO 10a obtains a supply voltage VDD_TC in response to a power source signal V_sup. In an embodiment, the LDO 10a is implemented with an integrated circuit IC10a, resistors R10a_1, R10a_2, and capacitors C10a_1 to C10a_3. For example, the power source signal V_sup corresponds to a voltage level, e.g. 12 Volts, higher than the supply voltage VDD_TC, e.g. 3.3 Volts or 5 Volts.

The switch push 10b, for example, includes pins #1 and #2 respectively coupled to the power node and receiving the supply voltage VDD_TC. In response to the user event, the switch push 10b further has the pin #1 and pin #2 shorted together, so as to provide the supply voltage VDD_TC to the power node and accordingly powers up the thermal cutoff circuit 1. For example, the user event is a button press operation performed on the switch push 10b executed by a user.

The switch push 10b, for example, further includes pins #5 and #6, wherein the pin #5 is coupled to the power switch unit 16 and receiving a ground voltage. In response to the user event, the switch push 10b further has the pin #5 and pin #6 shorted together, so as to provide the ground voltage to the power switch unit 16.

The thermal sensor 12 is powered up by the supply voltage VDD_TC for providing a thermal sense signal S_sense, which is active when a temperature of the electronic device exceeds a threshold T_th and is inactive when the temperature does not exceed the threshold T_th. For example, the thermal sense signal S_sense corresponds to a low level when it is inactive and corresponds to a high level when it is active. In an embodiment, the thermal sensor 12 is implemented with a resistor R12_2 and a thermistor R12_1, wherein the resistance of the thermistor R12_1 varies with the temperature thereof. The thermistor R12_1 is, for instance, located close to key components, e.g. CPU, of the electronic device, so as to carry out thermal sensing operation thereon.

In an embodiment, the resistance of the thermistor R12_1 is also tunable to determine the threshold T_th. In other words, the resistance of the thermistor R12_1 corresponds with the value of the threshold T_th.

The logic unit 14 is powered up by the supply voltage VDD_TC for providing a cutoff signal S_cut, wherein the cutoff signal S_cut is inactive when the thermal sense signal S_sense is inactive. The logic unit 14, for example, includes logic circuit 14a and 14b.

The logic circuit 14a provides a drive signal S_drive according to the thermal sense signal S_sense and the drive signal S_drive itself, wherein the drive signal S_drive is initialized as inactive. For example, the drive signal S_drive is inactive, e.g. corresponding to a low level, when the thermal sense signal S_sense and the drive signal S_drive are both inactive, e.g. corresponding to low levels. The drive signal S_drive is active, e.g. corresponding to a high level, when any one of the thermal sense signal S_sense and the drive signal S_drive is active, e.g. corresponding to a high level. In other words, the logic circuit 14a includes an OR gate for generating the drive signal S_drive by means of executing logic OR operation on the thermal sense signal S_sense and the drive signal S_drive fed back. In an embodiment, the logic circuit 14a is implemented with an OR gate circuit U14a, a resistor R14a, and a capacitor C14a.

The logic circuit 14b provides the cutoff signal S_cut according to the drive signal S_drive. For example, the cutoff signal S_cut is inactive, e.g. corresponding to a high level, when the drive signal S_drive is inactive, e.g. corresponding to a low level; and the cutoff signal S_cut is active, e.g. corresponding to a low level, when the drive signal S_drive is active, e.g. corresponding to a high level. In other words, the logic circuit 14b includes a NOT gate for generating the cutoff signal S_cut substantially inverse to the drive signal S_drive. In an embodiment, the logic circuit 14b is implemented with an NPN Bipolar transistor Q28, resistors R14b_1 to R14b_4.

The power switch unit 16, in response to the inactive cutoff signal S_cut, provides a system power signal VDD_ED to the electronic device according to the power source signal V_sup, so as to power up the electronic device. The power switch unit further stops providing the system power signal VDD_ED and accordingly has the electronic device powered off in response to the active cutoff signal S_cut. In an embodiment, the power switch unit 16 includes a power switch transistor Q22, a bias transistor Q26, and resistors R16_1 to R16_6. For example, the power switch transistor Q22 is a P channel metal oxide semiconductor (MOS) power transistor and the bias transistor Q26 is an NPN bipolar transistor.

The power switch transistor Q22 includes a source receiving the power source signal V_sup, a drain coupled to the electronic device, and a gate. The bias transistor Q26 includes a source receiving the ground voltage provided by the power switch 16b, a base receiving the cutoff signal S_cut, and a collector coupled to the gate of the power switch transistor Q22.

When the cutoff signal S_cut is inactive, e.g. corresponding to the high level, the bias transistor Q26 is turned on and the collector of the bias transistor Q26 is biased with a low voltage level. Thus, the power switch transistor Q22 is turned on and provides the system power signal VDD_ED according to the power source signal V_sup for powering up the electronic device.

When the cutoff signal S_cut is active, e.g. corresponding to the low level, the bias transistor Q26 is turned off and the collector of the bias transistor Q26 is biased with a high voltage level. Thus, the power switch transistor Q22 is turned off in response to the high voltage level of the collector and stops providing the system power signal VDD_ED to the electronic device.

As discussed in the above paragraphs, when the user event is triggered, the power unit 10 accordingly provides the supply voltage VDD_TC to power up the thermal cutoff circuit 1; the thermal sensor 12 provides the inactive thermal sense signal S_sense; the logic unit 14 provides the inactive drive signal S_drive (e.g. the initial drive signal S_drive) and the inactive cutoff signal S_cut; and the power switch unit 16 accordingly powers up the electronic device with the system power signal VDD_ED. Thus, the electronic device is powered up for executing its normal operation.

When the temperature of the electronic device exceeds a threshold T_th, the thermal sensor 12 provides the active thermal sense signal S_sense; the logic unit 14 provides the active drive signal S_drive and the active cutoff signal S_cut; and the power switch unit 16 stops providing the system power signal VDD_ED to the electronic device. Thus, the electronic device is accordingly powered off, so that the thermal cutoff protection is achieved.

In an embodiment, the temperature of the electronic device gradually becomes lower after the thermal cutoff protection is achieved. When the temperature of the electronic device is once again lower than the threshold T_th, the thermal sensor 12 once again provides the inactive thermal sense signal S_cut. However, the logic unit 14 keeps providing the active cutoff signal S_cut since the drive signal S_drive remains active; and the power switch unit 16 keeps not providing the system power signal VDD_ED to the electronic device. That is to say, the thermal cutoff circuit 1 according to the present embodiment of the invention is irrecoverable after the thermal cutoff protection has taken place. Under such condition, another user event, e.g. another power button pressing operation (power cycling) is required for initializing the thermal cutoff circuit 1, so as to power up the electronic device again.

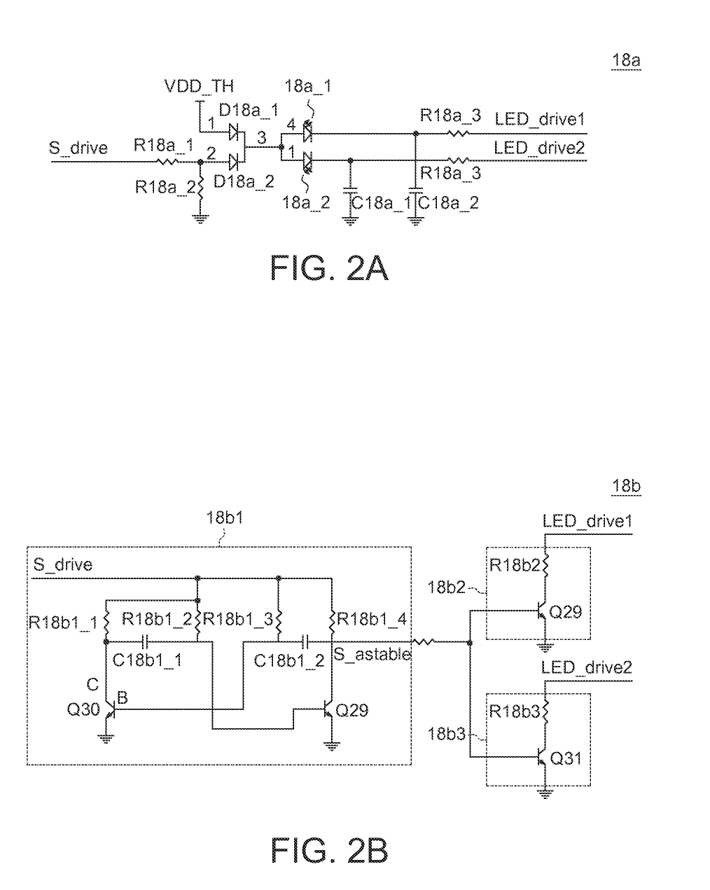

In an example, the thermal cutoff circuit 1 further includes a user interface circuit for triggering a user alarming event according to the drive signal S_drive. In an embodiment, the user alarming event is an event with flickering light, and the user interface circuit includes a light emitting diode (LED) unit 18a and an LED driver 18b, as respectively shown in FIGS. 2A and 2B. For example, the LED unit 18a includes LED light sources 18a1, 18a2, and a bias circuit, which includes resistors R18a1-18a4, diodes D18a_1, D18a_2, and capacitors C18a_1 and C18a_2 of the LED light sources 18a1 and 18a2.

The LED driver 18b drives the LED unit 18a for triggering a user alarming event according to the active drive signal S_drive. For example, the LED driver 18b includes an astable circuit 18b1, output stages 18b2 and 18b3. The astable circuit 18b1 provides an unstable drive signal S_astable in response to the active drive signal S_drive. In an embodiment, the astable circuit 18b1 includes transistors Q30, Q29, resistors R18b1_1 to R18b1_4 and capacitors C18b1_1 and C18b1_2.

The output stages 18b2 and 18b3 provide drive signals LED_drive1 and LED_drive2 respectively according to the unstable drive signal S_astable. For example, the unstable drive signal S_astable and the drive signals LED_drive1 and LED_drive2 are oscillation signals with their levels keeping altering between a high voltage level and a low voltage level. Thus, the LED light sources 18a1 and 18a2 accordingly provide flickering light in response to the drive signals LED_drive1 and LED_drive2, so as to triggering the user alarming event. In an embodiment, the output stage 18b2 includes a transistor Q33 and a resistor R18b2, and the output stage 18b3 includes a transistor Q31 and a resistor R18b3.

The thermal cutoff circuit according to the present embodiment of the invention employs a switch push for enabling a power switch to power up the electronic device in response to a user event. The thermal cutoff circuit further employs a circuit structure capable of preventing the switch push from damage caused by inrush current, which occurs when the electronic device is powered up. Thus, in comparison to conventional thermal cutoff schemes, the thermal cutoff circuit according to the present embodiment of the invention is capable of preventing the switch push from being damaged by inrush current.

### Second Embodiment

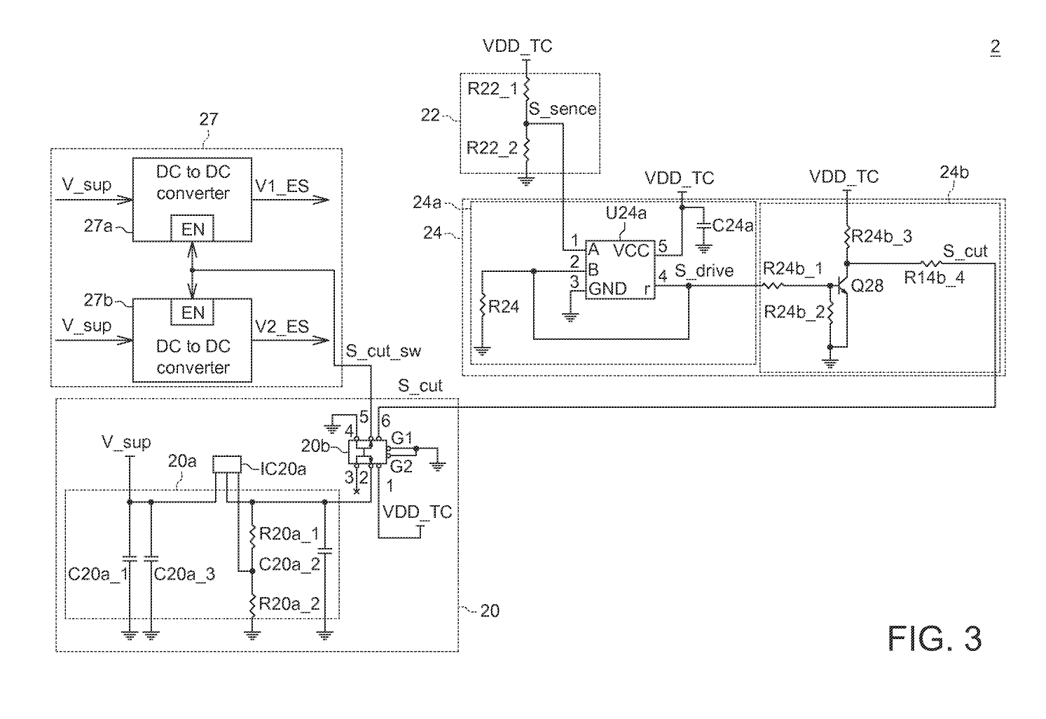

Referring to FIG. 3, a block diagram of the thermal cutoff circuit according to the second embodiment of the invention is shown. The thermal cutoff circuit 2 is different from the thermal cutoff circuit 2 of the first embodiment in that a DC to DC converter unit 27 is employed for powering up the electronic device. For example, the DC to DC converter unit 27 includes DC to DC converter 27a and 27b for respectively providing system power signals V1_ES and V2_ES according to the power source signal V_sup.

The switch push 20b, for example, includes pins #4, #5 and #6, wherein the pin #5 is coupled to the enable pin of the DC to DC converter unit 17, the pin #6 receives the cutoff signal S_cut, and the pin #4 is connect to ground. In response to the user event, the switch push 20b has the pings #5 and #6 shorted together, so as to provide the cutoff signal S_cut as an enable signal of the DC to DC converter unit 17.

When the cutoff signal S_cut is active, e.g. corresponding to the high level, the enable pins of the DC to DC converters 27a and 27b correspond to a high voltage level and the DC to DC converters 27a and 27b are enabled for providing the system power signals V1_ES and V2_ES to the electronic device.

When the temperature of the electronic device exceeds a threshold T_th, the thermal sensor 22 provides the active thermal sense signal S_sense; the logic unit 24 provides the active drive signal S_drive and the active cutoff signal S_cut. Under this circumstance, the enable pins of the DC to DC converters 27a and 27b correspond to a low voltage level and the DC to DC converters 27a and 27b are disabled for not providing the system power signals V1_ES and V2_ES to the electronic device. Thus, the electronic device is accordingly powered off, so that the thermal cutoff protection is achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A thermal cutoff circuit for a electronic device, comprising:
a power unit, comprising:
a power switch for powering up the thermal cutoff circuit with a supply voltage in response to a user event;
a thermal sensor, powered up by the supply voltage for providing a thermal sense signal, which is active when a temperature of the electronic device exceeds a threshold and is inactive when the temperature does not exceed the threshold;
a logic unit, powered up by the supply voltage for providing a cutoff signal, which is inactive when the thermal sense signal is inactive; and
a power switch unit, turned on for powering up the electronic device with a power source signal according to the inactive cutoff signal, wherein,
the logic unit further provides the cutoff signal, which is active, according to the active thermal sense signal; and
the power switch unit is accordingly turned off and stops powering up the electronic device according to the active cutoff signal, so as to achieve thermal cutoff of the electronic device.

2. The thermal cutoff circuit according to claim 1, wherein the power unit comprises:
a power node, coupled to the thermal sensor and the logic unit; and
a level shifter, obtaining the supply voltage in response to the power source signal, wherein,
the power switch (power push button) provides the supply voltage to the power node in response to the user event, so as to power up the thermal sensor and the logic unit.

3. The thermal cutoff circuit according to claim 2, wherein the power switch further provides a ground voltage to the power switch unit in response to the user event.

4. The thermal cutoff circuit according to claim 3, wherein the power switch unit comprises:
a power switch transistor, turned on for powering up the electronic device with the power source signal and turned off for stopping powering up the electronic device; and
a bias transistor, comprising an emitter receiving the ground voltage, a base receiving the cutoff signal, and a collector coupled to the power switch transistor.

5. The thermal cutoff circuit according to claim 1, wherein the logic unit comprises:
a first logic circuit, for providing a drive signal, which is initialized as inactive, according to the thermal sense signal and the drive signal, wherein the drive signal is inactive when the thermal sense signal and the drive signal are both inactive and the drive signal is active when the thermal sense signal or the drive signal is/are active; and
a second logic circuit, for providing the inactive cutoff signal according to the inactive drive signal and providing the active cutoff signal according to the active drive signal.

6. The thermal cutoff circuit according to claim 5, further comprises:
a user interface circuit, for triggering a user alarming event according to the active drive signal.

7. The thermal cutoff circuit according to claim 6, wherein the user interface circuit comprises:
a light emitting diode (LED) unit; and
a LED driver, for driving the LED unit for driving the LED unit triggering the user alarming event according to the active drive signal.

8. The thermal cutoff circuit according to claim 1, wherein the thermal sensor comprises:
a temperature sensitive resistor, having a tunable resistor, wherein the resistance of the tunable resistor corresponds to the threshold.
